(19) United States
(12) Patent Application Publication
(10) Pub. No.: US 2023/0349109 A1
(43) Pub. Date: Nov. 2, 2023

(54) SYSTEM AND METHOD FOR CONTROLLING ALIGNMENT OF MACHINES DURING OPERATIONS

(71) Applicant: Caterpillar Paving Products Inc., Brooklyn Park, MN (US)

(72) Inventors: Paul Joseph Koenen, Andover, MN (US); Garrett Daniel Reed, Big Lake, MN (US)

(73) Assignee: Caterpillar Paving Products Inc., Brooklyn Park, MN (US)

(21) Appl. No.: 17/660,839

(22) Filed: Apr. 27, 2022

(51) Int. Cl. E01C 23/088; G01B 11/26

(52) U.S. Cl. CPC E01C 23/088; G01B 11/26

(57) ABSTRACT

A system for controlling an alignment of a first machine with respect to a second machine. The system includes a projector mounted on the second machine. The projector is configured to project one or more light beams. The system further includes an image capturing device configured to capture one or more images of the first machine and the one or more light beams. The system further includes a controller configured to determine a position of the first machine with respect to the one or more light beams based on the one or more images and generate an alert when one or more characteristics of the one or more light beams shifts from a first condition to a second condition.

### TECHNICAL FIELD

The present disclosure relates to a method and a system for controlling an alignment of a first machine with respect to a second machine during operations, such as a milling operation.

### BACKGROUND

During operations, such as a milling operation, at least two machines (e.g., a milling machine and a haul (or dump) truck) are generally required to co-ordinate their positions with respect to each other. For example, to perform a milling operation, as the milling machine travels, a milling drum of the milling machine may engage with an underlying surface and break up the underlying surface to generate milled materials. Simultaneously, the haul truck may also travel along with the milling machine in order to receive the milled materials generally ejected from a conveyor system of the milling machine.

To avoid situations when a spillage of the milled materials can occur outside the haul truck, such as when the haul truck is too far from or too close to the milling machine, operators generally rely on manual signaling techniques to adjust the alignment of the haul truck with respect to the conveyor system of the milling machine. These manual signaling techniques typically require the milling machine operators to monitor the alignment of the haul truck with respect to the conveyor system of the milling machine and manually send positioning signals to the haul truck operator, such as with the blast of a horn or activation of a light source. These techniques can burden or distract the milling machine operator from other aspects of the milling operation and may also involve the operator's subjective interpretation of the alignment of the haul truck with respect to the conveyor system. Further, the manual signals can be difficult for truck operators to interpret at times, which may result in miscalculated control of the haul truck and material spillage.

### SUMMARY

In one aspect, the disclosure relates to a system for controlling an alignment of a first machine with respect to a second machine. The system includes a projector mounted on the second machine. The projector is configured to project one or more light beams. The system further includes an image capturing device configured to capture one or more images of the first machine and the one or more light beams. The system further includes a controller configured to determine a position of the first machine with respect to the one or more light beams based on the one or more images and generate an alert when one or more characteristics of the one or more light beams shifts from a first condition to a second condition.

In another aspect, the disclosure is directed to a method for controlling an alignment of a first machine with respect to a second machine. The method includes projecting, by a projector mounted on the second machine, one or more light beams and capturing, by an image capturing device, one or more images of the first machine and the one or more light beams. The method further includes determining, by a controller, a position of the first machine with respect to the one or more light beams based on the one or more images and generating, by the controller, an alert when one or more characteristics of the one or more light beams shifts from a first condition to a second condition.

In yet another aspect, the disclosure is related to a machine system. The machine system includes a dump truck, a milling machine configured to perform a milling operation and transfer milled material to the dump truck, and a system for controlling an alignment of the dump truck with respect to the milling machine. The system includes a projector mounted on the milling machine, the projector configured to project one or more light beams and an image capturing device configured to capture one or more images of the dump truck and the one or more light beams. The system further includes a controller configured to determine a position of the dump truck with respect to the one or more light beams based on the one or more images and generate an alert when one or more characteristics of the one or more light beams shifts from a first condition to a second condition.

### BRIEF DESCRIPTION OF THE DRAWINGS

FIG. 1 illustrates an environment employing an exemplary machine system having a first machine and a second machine, in accordance with one or more aspects of the present disclosure;

FIG. 2 is a schematic view of an exemplary system for controlling an alignment of the first machine with respect to the second machine, in accordance with one or more aspects of the present disclosure;

FIGS. 3 through 8 illustrate one or more exemplary light beams generated by a projector of the system for controlling the alignment of the first machine with respect to the second machine, in accordance with one or more aspects of the present disclosure; and

FIG. 9 illustrates an exemplary method for controlling the alignment of the first machine with respect to the second machine, in accordance with one or more aspects of the present disclosure.

### DETAILED DESCRIPTION

Reference will now be made in detail to specific embodiments or features, examples of which are illustrated in the accompanying drawings. Wherever possible, the same reference numbers will be used throughout the drawings to refer to the same or like parts.

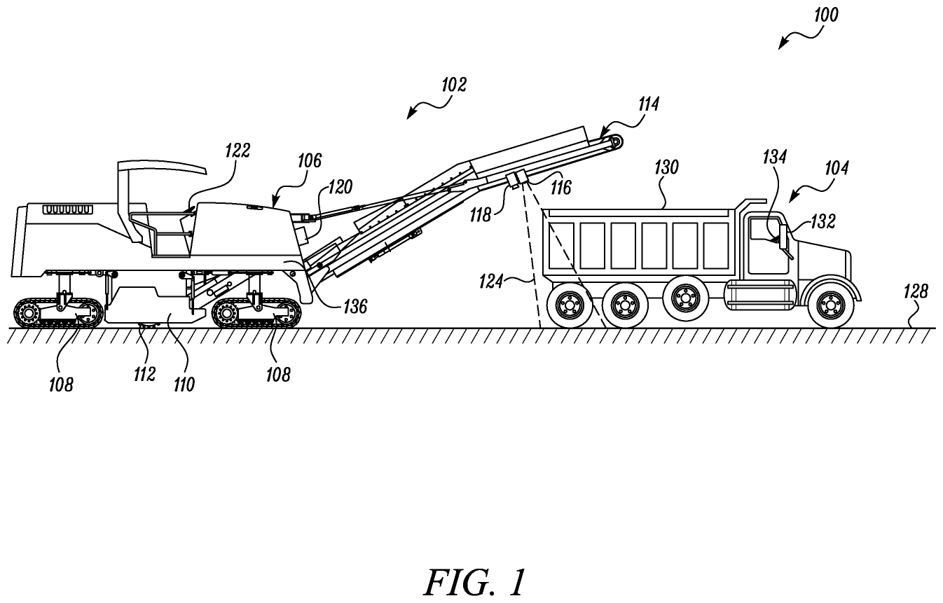

Referring to FIG. 1, an exemplary environment 100 employing a machine system 102 performing an exemplary milling operation is shown. The machine system 102 includes a first machine 104 and a second machine 106. The second machine 106 may include a milling machine, such as a roadway/pavement profiler, a roadway planer, a cold planer, and/or the like. The second machine 106 may be used to perform a milling operation to modify a ground surface 128 and transfer milled materials into the first machine 104 during the milling operation. For example, the milling operation may mean or include one or more of scarifying, removing, mixing, and/or reclaiming material, from the ground surface 128. The ground surface 128 may be a worn-out surface formed from one or more of asphalt, bitumen, concrete, and/or other road surface materials. One or more layers of the ground surface 128 may be milled and removed by way of the milling operation for the laying of a new ground surface.

The second machine 106 may include a set of traction devices 108, a milling assembly 110, a conveyor system 114, an operator station 122, and a frame 136, to support and propel the second machine 106 over an expanse of the ground surface 128. The frame 136 supports the operator station 122. The operator station 122 may house any number of interface devices and control devices (e.g., a throttle control, a braking control, a steering device, etc.) that an operator may use to control the set of traction devices 108, the milling assembly 110, and the conveyor system 114 of the second machine 106.

The traction devices 108 may include tracks, wheels, or a combination thereof. Exemplarily, the second machine 106 may include four traction devices (one at each corner of the frame 136 of the second machine 106), although lesser or greater numbers of traction devices may be contemplated. The traction devices 108 may be adjustably supported on a frame 136 of the second machine 106 and may be moved or varied independently with respect to the frame 136, such that a distance (e.g., a height) of the frame 136 may be varied relative to the traction devices 108, allowing the frame 136 to acquire a desired orientation with respect to the ground surface 128.

The milling assembly 110 may be supported by the frame 136 and may be configured to facilitate the milling operation. During a milling operation, the ground surface 128 may be milled by the milling assembly 110 as the second machine 106 moves over the ground surface 128. The milling operation facilitates disintegration of one or more layers of the ground surface 128 to result in milled materials and thus a milled ground surface. The milling assembly 110 may include a milling drum 112. The milling drum 112 may be applied to engage and mill the ground surface 128 during the milling operations so as to obtain the milled materials and thus the milled ground surface. The milling drum 112 may grind and scrape off a top of the ground surface 128 or one or more layers (e.g., top layers) of the ground surface 128 that the milling drum 112 may come in contact with. In so doing, such layers of the ground surface 128 may break into rubble, dust, and debris, and may result in the formation of the milled materials which may be transferred to the conveyor system 114 so as to clear the milled ground surface of the milled materials. The conveyor system 114 may in turn convey the milled materials into the first machine 104 that may move ahead of the second machine 106 during the milling operation.

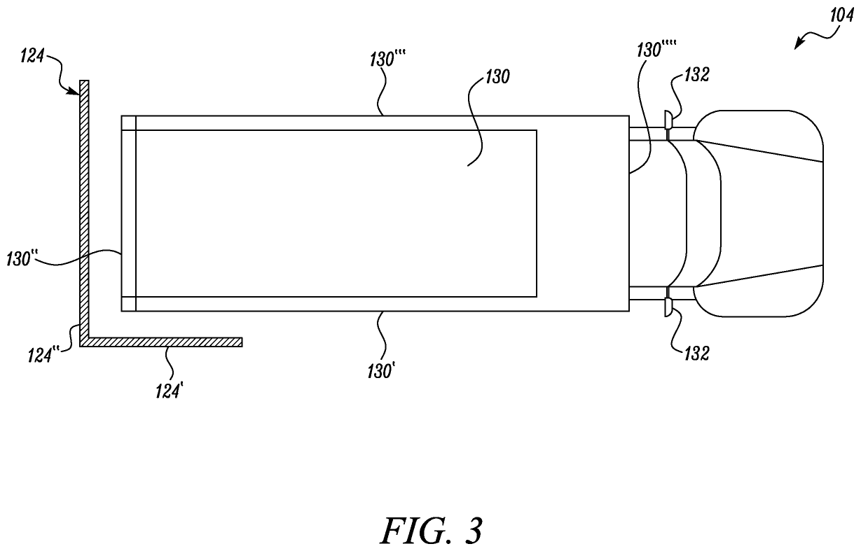

The first machine 104 may be a mobile machine for example, a dump truck, an articulated dump truck, a tractor-trailer, etc. The first machine 104 may be configured to receive the milled material from the second machine 106 and transport the milled material from a first location to a second location. The first machine 104 may include an open-box bed, such as a dump body 130 to receive the milled material from the second machine 106. The dump body 130 may include a rectangular-shaped body with a first side wall 130′, a rear side wall 130″, a second side wall 130′″, and a front side wall 130″″ (as shown in FIGS. 3 through 8). It will be appreciated by persons skilled in the art that although the dump body 130 is shown to be rectangular in shape, the dump body 130 may alternatively be of any other shape, such as, half-round, semi-elliptical, etc., in accordance with various aspects of the present disclosure.

The first machine 104 may include an operator station 134 which may include various controls, such as a throttle control, a braking control, a steering device, etc., within the operator station 134, that may allow the first machine 104 to be controlled by an operator stationed within the operator station 134 of the first machine 104. The first machine 104 may further include mirrors, e.g., rear view mirrors, that may help one or more operators stationed within the operator station of the first machine 104 to obtain a rearward view (including portions of the second machine) of the first machine 104. For example, an operator of the first machine 104 may use the mirrors 132 and one or more control devices (e.g., the throttle control, the braking control, and/or the steering device) to cause the first machine 104 to travel in front or ahead of the second machine 106 such that the first machine 104 may be able to receive the milled material from the conveyor system 114 as the second machine 106 traverses the ground surface 128. When the dump body 130 receives a full load of the milled material, the first machine 104 may depart to deliver the milled material to a storage site, processing plant, or any other facility, and another first machine (similar to the first machine 104) may approach and take the place of the first machine 104 so as to receive the milled materials and so that the milling operation can continue.

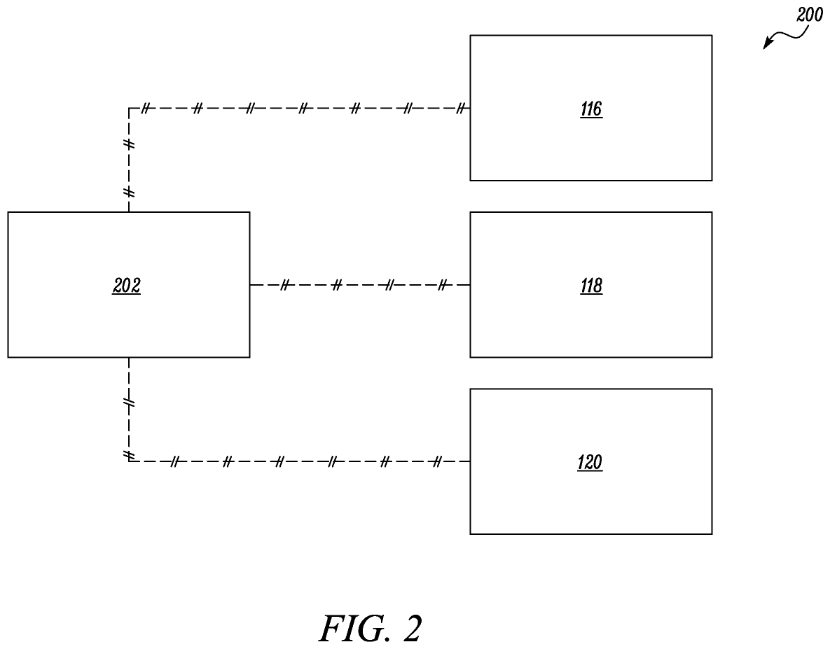

Referring to FIG. 2, details of an exemplary system 200 for controlling the alignment of the first machine 104 with respect to the second machine 106 are illustrated. In an exemplary embodiment, the system 200 includes a controller 202 and a projector 116, an image capturing device 118, and an output device 120 operatively coupled to the controller 202.

The projector 116 may be an optical device that projects one or more light beams 124 on the ground surface 128 and/or on the first machine 104. The projector 116 includes a light source (not shown), such as a laser light source, for projecting the light beams 124. The projector 116 may be mounted on the conveyor system 114 (e.g., to an underside of the conveyor system 114) of the second machine 106. It will be appreciated by persons skilled in the art that although the projector 116 is shown to be mounted to the underside of the conveyor system 114, the projector 116 may alternatively be installed at any portion of the second machine 106 to project the light beams 124, in accordance with various aspects of the present disclosure.

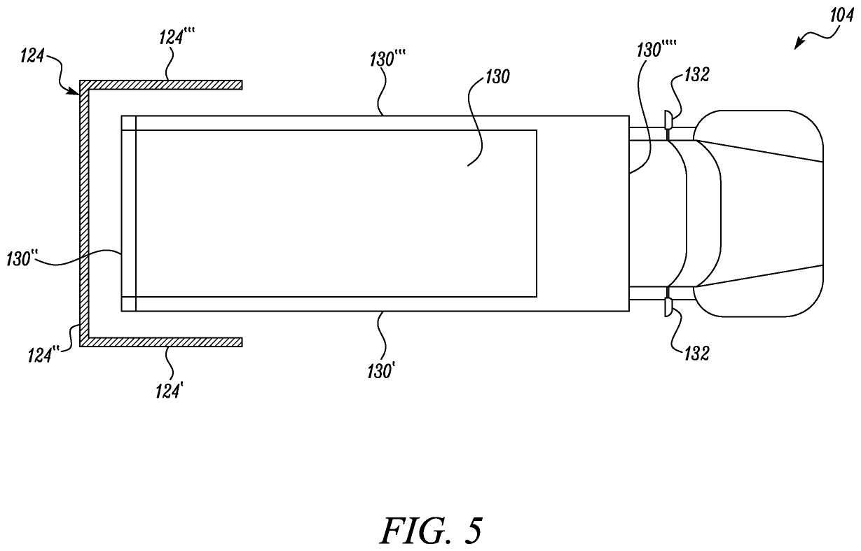

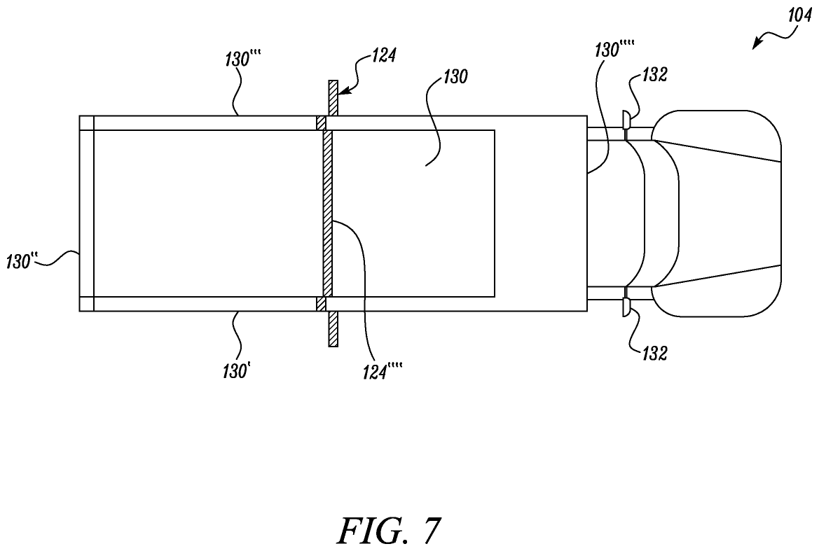

In accordance with various embodiments of the present disclosure, the projector 116 is configured to project the light beams 124 on the ground surface 128 and/or the first machine 104 to form different patterns, depending upon the preferences of the worksite operator(s) or upon the type of the first machine 104 and/or the second machine 106. For example, in some embodiments, and as shown in FIG. 3, the light beams 124 include at least two light beams 124′, 124″ that are configured to be projected on the ground surface 128 to form an L-shaped (that is, orthogonal) pattern on the ground surface 128 and align with at least two corresponding sides, i.e., the first side wall 130′ and the rear side wall 130″ of the first machine 104. Such an L-shaped pattern may be used for side loading. In some embodiments, as shown in FIG. 5, the light beams 124 include at least three light beams 124′, 124″, 124″ that are configured to be projected on the ground surface 128 to form a U-shaped pattern (having two straight side segments intersecting an orthogonal straight bottom segment) on the ground surface 128 and align with at least three corresponding sides, i.e., the first side wall 130′, the rear side wall 130″, and the second side wall 130′″ of the first machine 104. In some embodiments, the two straight side segments are parallel to each other. Such a U-shaped pattern may be used for front loading. In some embodiments, and as shown in FIG. 7, the one or more light beams 124 include a light beam 124″″ configured to be projected laterally across the first machine 104 such that the light beam 124″″ is projected in-part on a portion of the front side wall 130″″ of the first machine 104 and in-part on the ground surface 128. Such pattern may be used independently for both side loading and front loading or may also be combined with other L-shaped and U-shaped patterns. In some embodiments, the light beams 124 may also act as reference lines for the operator of the first machine 104 while aligning the first machine 104 with respect to the second machine 106.

The image capturing device 118 is configured to capture images of the light beams 124 and the first machine 104. The image capturing device 118 may include a camera or a combination of cameras. The image capturing device is configured to capture a sequence of images at regular intervals, for example, at 30 frames per second. Examples of the images may include, but not limited to, two-dimensional images, three-dimensional images, and so on. The image capturing device 118 may be installed on the conveyor system 114 of the second machine 106 and may be configured to capture one or more images of the first machine 104 with respect to the light beams 124. It will be appreciated by persons skilled in the art that although the image capturing device 118 is shown to be mounted to an underside of the conveyor system 114, the image capturing device 118 may alternatively be installed at any portion of the second machine 106 from where the image capturing device 118 may be able to capture the images of the first machine 104 and the light beams 124, in accordance with various aspects of the present disclosure.

The controller 202 may include one or more microprocessors, microcomputers, microcontrollers, programmable logic controller, DSPs (digital signal processors), central processing units, state machines, logic circuitry, or any other device or devices that process/manipulate information or signals based on operational or programming instructions. The controller 202 may be implemented using one or more controller technologies, such as Application Specific Integrated Circuit (ASIC) technology, Reduced Instruction Set Computing (RISC) technology, Complex Instruction Set Computing (CISC) technology, etc.

The controller 202 is configured to determine a position of the first machine 104 with respect to the light beams 124 based on the images. To this end, the controller 202 is configured to obtain the images of the light beams 124 and the first machine 104 from the image capturing device 118 and determine whether one or more characteristics of the light beams 124 shifts from a first condition to a second condition. The characteristics include a continuity of the light beams 124.

In accordance with various embodiments of the present disclosure, the first condition of the light beams 124 represents an ideal alignment/positioning of the first machine 104 with respect to the light beams 124 and/or the second machine 106 for the milling operations. For example, FIG. 3 represents the first condition of the light beams 124′, 124″ that corresponds to a continuous condition of each of the light beams 124′, 124″. In such cases, the positioning of the sides (for example, the first side wall 130′ and the rear side wall 130″) of the first machine 104 with the light beams 124′, 124″ is considered as the ideal alignment of the first machine 104 for the milling operations. Similarly, FIG. 5 represents the first condition of the light beams 124′, 124″, 124′″ that corresponds to the continuous condition of each of the light beams 124′, 124″, 124″. In such cases, the positioning of the sides (for example, the first side wall 130′, the rear side wall 130″, and the second side wall 130′″) of the first machine 104 within the boundaries of the light beams 124′, 124″, 124′″ is considered the ideal alignment of the first machine 104 for the milling operations. In some embodiments, such as shown in FIG. 7, the first condition of the light beam 124″″ corresponds to the broken condition of the light beam 124″″. As shown, in such cases, a portion of the light beam 124“ ” falls on various sections, for example, one on the ground surface 128, one on the first side wall 130′, one on the second side wall 130′″, and one on the bed of the dump body 130, each of which may be disposed at or along different planes and gradients, thus breaking the continuity of the light beam 124″″. In accordance with various embodiments, the projection of the light beam 124″ ″ in-part across the first machine 104 and in-part on the ground surface 128 is considered the ideal positioning of the first machine 104 for the milling operations.

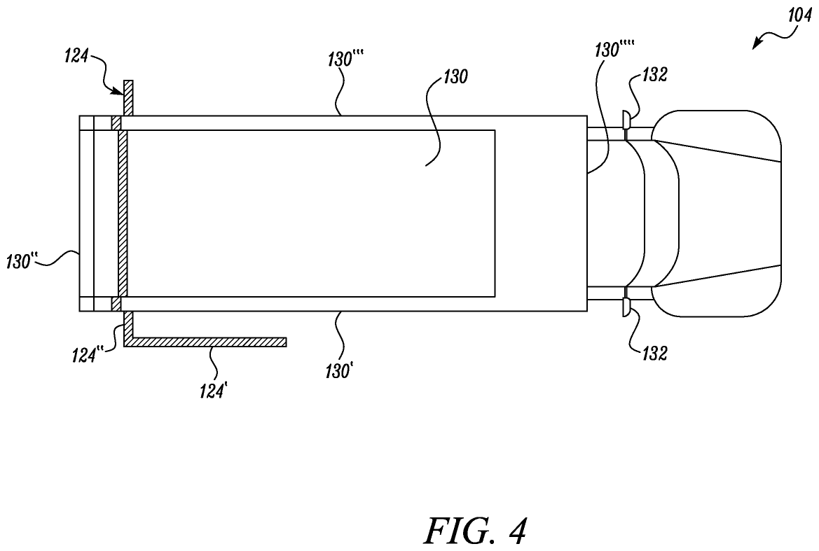

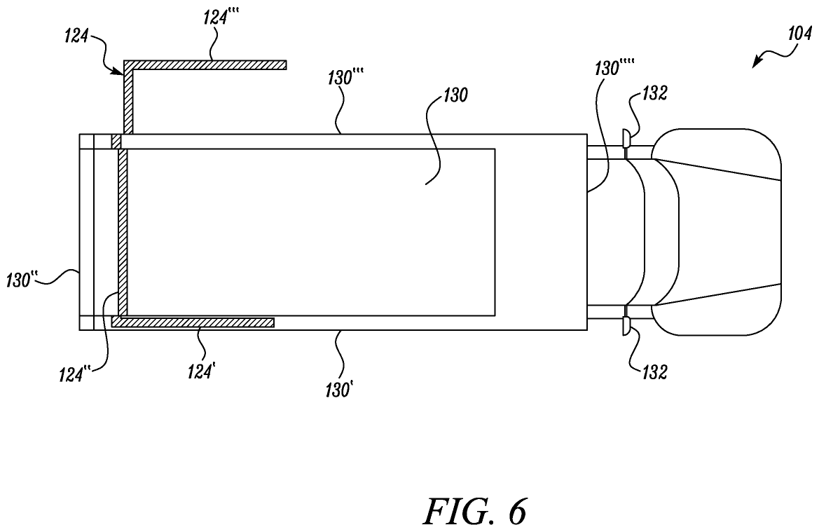

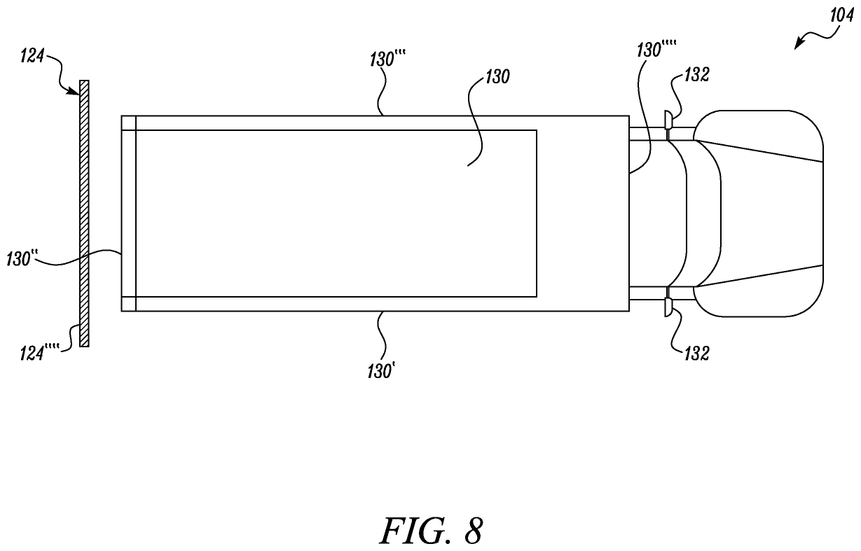

The second condition of the light beams 124 represents a misaligned position of the first machine 104 with respect to the light beams 124 and/or the second machine 106 for the milling operations. For example, FIG. 4 represents the second condition of the light beams 124′, 124″ that corresponds to a broken condition of the light beam 124″. In such cases, the broken condition of the light beam 124′ is attained due to an overlap of the first machine 104 on or over the light beam 124′ and the same is considered as the misaligned positioning of the first machine 104 for the milling operations. Similarly, FIG. 6 represents the second condition of the light beams 124′, 124″, 124′″ that corresponds to the broken condition of the light beams 124′, 124″. In such cases, the broken condition of the light beams 124′, 124″ is attained due to an overlap of the first machine 104 on or over the light beam 124′, 124″ and the same is considered as the misaligned positioning of the first machine 104 for the milling operations. In some embodiments, such as shown in FIG. 8, the second condition of the light beam 124″″ corresponds to the continuous condition of the light beam 124″. In such cases, the projection of the light beam 124″″ may fall outside of the first machine 104, e.g., completely on the ground surface 128, and may become continuous as it falls on the ground surface 128, and the same is considered as the misaligned positioning of the first machine 104 for the milling operations.

The controller 202 may be configured to utilize various image processing techniques to determine the change in the characteristics of the light beams 124. To this end, the controller 202 may be configured to compare pixel values of those pixel frames corresponding to the light beams 124 in the sequence of images to determine any change in the pixel values of such pixel frames. The controller 202 is further configured to compare the change in the pixel value with a threshold change value. When the change in the pixel value is greater than the threshold change value, the controller 202 is configured to designate the light beams 124 as discontinuous light beams corresponding to the broken condition of the light beams 124. When the change in the pixel value is less than or equal to the threshold change value, the controller 202 is configured to designate the light beams 124 as continuous light beams corresponding to the continuous condition of the light beams 124. The threshold change value distinguishes between the discontinuity owing to the light beams encountering rocks and stones and the discontinuity owing to the light beams encountering parts of the first machine 104.

When the first condition of the light beams 124 corresponds to the continuous condition, the controller 202 may be configured to compare various pixel frames in the sequence of images captured by the image capturing device 118 to determine if there is any discontinuity (i.e., the second condition) detected in the light beams 124. Similarly, when the first condition of the light beams 124 corresponds to the broken condition, the controller 202 may be configured to compare various pixel frames in the sequence of images captured by the image capturing device 118 to determine if there is any continuity (i.e., the second condition) detected in the light beams 124.

The controller 202 is further configured to control the output device 120 to generate an alert when the characteristics of the light beams 124 shift from the first condition to the second condition. The output device 120 may include an audio or visual indicator, e.g., a machine horn, configured to provide one or more indications to the operator of the first machine 104 to align the first machine 104 with respect to the light beams 124. In some embodiments, the controller 202 is configured to generate the alert by changing a color of the light beams 124 from a first color to a second color.

### INDUSTRIAL APPLICABILITY

At the start and/or during operations, if the first machine 104 is to travel ahead (e.g., directly ahead) of the second machine 106, the first machine 104 may be positioned right ahead of the second machine 106 such that an exit or outlet of the conveyor system 114 can be brought right above the dump body 130 somewhat forward (in the intended direction of vehicle travel) from the rear side wall 130″. Thereafter, as the second machine 106 begins to process the ground surface 128, the milled materials are generated and they are delivered to the dump body 130. The U-shaped pattern, shown in FIG. 5, may be used in such cases.

It may happen, in some environments, that the first machine 104 has to be deployed at an angle to the second machine 106 such that an exit or outlet of the conveyor system 114 can be brought right above the dump body 130 and slightly inboard from the first side wall 130′ or the second side wall 130′″. The L-shaped pattern, shown in FIG. 3, may be used in such cases.

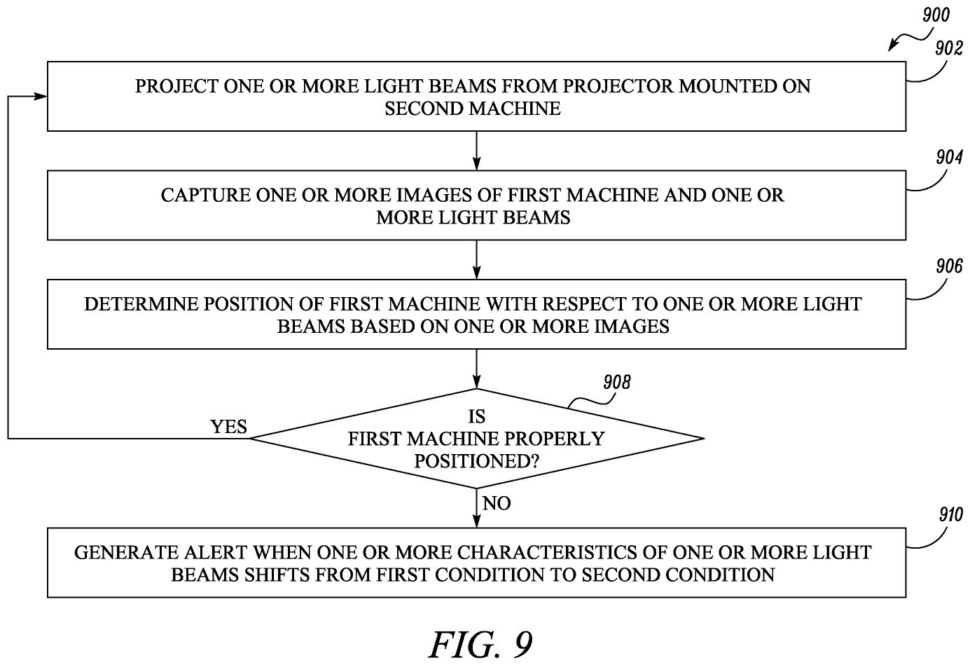

FIG. 9 illustrates an exemplary flow chart of a method 900 for controlling the alignment of the first machine 104 with respect to the second machine 106. The method 900 begins at step 902 with the projector 116 projecting the light beams 124. At step 904, the image capturing device 118 captures the images of the first machine 104 and the light beams 124. At step 906, the controller 202 determines the position of the first machine 104 with respect to the light beams 124 based on the images. At step 908, the controller 202 determines whether the first machine 104 is properly positioned with respect to the light beams 124. To this end, the controller 202 determines whether the characteristics of the light beams 124 correspond to the first condition. When the first machine 104 is not properly positioned with respect to the light beams 124, the method proceeds to step 910 with the controller 202 generating the alert when the characteristics of the light beams 124 shifts from the first condition to the second condition. When the first machine 104 is properly positioned with respect to the light beams 124, the method loops back to the step 902.

The system and method of the present disclosure provide an efficient solution to precisely align the first machine 104, such as the dump truck, with the second machine 106, such as the milling machine. The proper alignment avoids situations when the first machine 104 is too far from or too close to the second machine 106, thus preventing spillage of the milled materials outside the first machine 104. Moreover, with the system and method of the present disclosure, the operators can be automatically alerted whenever the machines 104, 106 are misaligned. This takes off the pressure from the operators to rely on and interpret the manual signals while operating the machines 104, 106.

It will be apparent to those skilled in the art that various modifications and variations can be made to the method and/or system of the present disclosure without departing from the scope of the disclosure. Other embodiments will be apparent to those skilled in the art from consideration of the specification and practice of the method and/or system disclosed herein. It is intended that the specification and examples be considered as exemplary only, with a true scope of the disclosure being indicated by the following claims and their equivalent.

What is claimed is:

1. A system for controlling an alignment of a first machine with respect to a second machine, the system comprising:
a projector mounted on the second machine, the projector configured to project one or more light beams;
an image capturing device configured to capture one or more images of the first machine and the one or more light beams; and;
a controller configured to:
determine a position of the first machine with respect to the one or more light beams based on the one or more images, and
generate an alert when one or more characteristics of the one or more light beams shifts from a first condition to a second condition.

2. The system of claim 1, wherein the one or more characteristics include a continuity of the one or more light beams, and the first condition corresponds to a continuous condition of the one or more light beams and the second condition corresponds to a broken condition of the one or more light beams.

3. The system of claim 1, wherein the one or more characteristics include a continuity of the one or more light beams, and the first condition corresponds to a broken condition of the one or more light beams and the second condition corresponds to a continuous condition of the one or more light beams.

4. The system of claim 1, wherein the one or more light beams include at least two light beams that are configured to be projected on a ground surface to form an L-shaped pattern on the ground surface and align with at least two corresponding sides of the first machine.

5. The system of claim 1, wherein the one or more light beams include at least three light beams that are configured to be projected on a ground surface to form a U-shaped pattern on the ground surface and align with at least three corresponding sides of the first machine, wherein each segment of the U-shaped pattern is straight.

6. The system of claim 1, wherein the one or more light beams include a light beam configured to be projected laterally across the first machine such that the light beam is projected in-part on a portion of the first machine and in-part on a ground surface.

7. The system of claim 1, wherein the controller is configured to generate the alert by changing a color of the one or more light beams.

8. A method for controlling an alignment of a first machine with respect to a second machine, the method comprising:
projecting, by a projector mounted on the second machine, one or more light beams;
capturing, by an image capturing device, one or more images of the first machine and the one or more light beams;
determining, by a controller, a position of the first machine with respect to the one or more light beams based on the one or more images; and
generating, by the controller, an alert when one or more characteristics of the one or more light beams shifts from a first condition to a second condition.

9. The method of claim 8, wherein the one or more characteristics include a continuity of the one or more light beams, and the first condition corresponds to a continuous condition of the one or more light beams and the second condition corresponds to a broken condition of the one or more light beams.

10. The method of claim 8, wherein the one or more characteristics include a continuity of the one or more light beams, and the first condition corresponds to a broken condition of the one or more light beams and the second condition corresponds to a continuous condition of the one or more light beams.

11. The method of claim 8, wherein projecting the one or more light beams includes projecting at least two light beams on a ground surface to form an L-shaped pattern on the ground surface and align with at least two corresponding sides of the first machine.

12. The method of claim 8, wherein projecting the one or more light beams includes projecting at least three light beams on a ground surface to form a U-shaped pattern on the ground surface and align with at least three corresponding sides of the first machine, wherein each segment of the U-shaped pattern is straight.

13. The method of claim 8, wherein projecting the one or more light beams includes projecting a light beam laterally across the first machine such that the light beam is projected in-part on a portion of the first machine and in-part on a ground surface.

14. The method of claim 8, wherein generating the alert includes changing a color of the one or more light beams.

15. A machine system, comprising:
a dump truck;
a milling machine configured to perform a milling operation and transfer milled material to the dump truck; and
a system for controlling an alignment of the dump truck with respect to the milling machine, the system including:
a projector mounted on the milling machine, the projector configured to project one or more light beams;
an image capturing device configured to capture one or more images of the dump truck and the one or more light beams; and
a controller configured to:
determine a position of the dump truck with respect to the one or more light beams based on the one or more images, and
generate an alert when one or more characteristics of the one or more light beams shifts from a first condition to a second condition.

16. The machine system of claim 15, wherein the one or more characteristics include a continuity of the one or more light beams, and the first condition corresponds to a continuous condition of the one or more light beams and the second condition corresponds to a broken condition of the one or more light beams.

17. The machine system of claim 15, wherein the one or more characteristics include a continuity of the one or more light beams, and the first condition corresponds to a broken condition of the one or more light beams and the second condition corresponds to a continuous condition of the one or more light beams.

18. The machine system of claim 15, wherein the one or more light beams include at least two light beams that are configured to be projected on a ground surface to form an L-shaped pattern on the ground surface and align with at least two corresponding sides of the dump truck.

19. The machine system of claim 15, wherein the one or more light beams include at least three light beams that are configured to be projected on a ground surface to form a U-shaped pattern on the ground surface and align with at least three corresponding sides of the dump truck, wherein each segment of the U-shaped pattern is straight.

20. The machine system of claim 15, wherein the one or more light beams include a light beam configured to be projected laterally across the dump truck such that the light beam is projected in-part on a portion of the dump truck and in-part on a ground surface.
